(19) United States
(12) Patent Application Publication
(10) Pub. No.: US 2005/0108093 A1
(43) Pub. Date: May 19, 2005

(54) Electronic commerce method and system

(76) Inventors: Micheal Cumming, Kurrajong (AU); Andrew Leimgruber, Kurrajong (AU)

Correspondence Address: Richard J. Streit;Ladas & Parry LLP, Suite 1200, 224 South Michigan Avenue, Chicago, IL, 60604, US

(21) Appl. No.: 10/950,335

(22) Filed: Sep. 24, 2004

(30) Foreign Application Priority Data
Sep. 26, 2003 (AU) 2003 905291

(51) Int. Cl. G06F 17/60

(52) U.S. Cl. 705/14

(57) ABSTRACT

In an electronic commerce method and system, an issuing party issues to a customer a carrier device having a plurality of electronic coupons stored thereon, in exchange for a fee. The carrier device includes an encoded contract including a redemption condition relating to each coupon, wherein each redemption condition includes a specified range of dates during which its respective coupon may be redeemed. The customer presents the carrier device to a redemption party, who electronically reads the encoded contract and verifies whether the redemption condition is satisfied. If the redemption condition is satisfied, the coupon is updated to indicate that the coupon has been redeemed.

### FIELD OF THE INVENTION

The present invention relates to an electronic commerce method and system wherein pre-paid electronic coupons which can be exchanged for goods or services are stored on a carrier device.

### BACKGROUND OF THE INVENTION

It is known to bulk sell goods or services by sale of a carrier device, such as a paper card with a magnetic strip or a smart card, the carrier device having stored thereon a simple counter which decrements as the card is used to obtain units of goods or services. Examples of such systems are pre-paid telephone cards for use in public telephones or travel tickets which are valid for a set number of journeys. As credit is used on a telephone card, or a travel ticket is passed through a security barrier, the counter reduces the credit available on the card.

Other electronic coupon systems such as that described in AU 200213544 require online verification at the point of exchange, which requires a complex and resource intensive network.

### SUMMARY OF THE INVENTION

According to the present invention, an electronic commerce method comprises the steps of:
a) an issuing party issuing to a customer a carrier device having a plurality of electronic coupons stored thereon, in exchange for a fee, wherein the carrier device includes an encoded contract including a redemption condition relating to each coupon, wherein each redemption condition includes a specified range of dates during which its respective coupon may be redeemed;
b) the customer presenting the carrier device to a redemption party;
c) the redemption party electronically reading the encoded contract and verifying whether the redemption condition is satisfied; and
d) if the redemption condition is satisfied, updating the coupon to indicate that the coupon has been redeemed.

The present invention also provides an electronic commerce system comprising:
a) an issuing party;
b) a carrier device issued to a customer by the issuing party in exchange for a fee, the carrier device having a plurality of electronic coupons stored thereon, wherein the carrier device includes an encoded contract including a redemption condition relating to each coupon, wherein each redemption condition includes a specified range of dates during which its respective coupon may be redeemed;
c) a redemption party having a reader device capable of reading the carrier device presented by the customer, electronically reading the encoded contract and verifying whether the redemption condition is satisfied and, if the redemption condition is satisfied, updating the coupon to indicate that the coupon has been redeemed.

The present invention also provides a carrier device having a plurality of electronic coupons stored thereon, wherein the carrier device includes an encoded contract including a redemption condition relating to each coupon, wherein each redemption condition includes a specified range of dates during which its respective coupon may be redeemed.

The present invention also provides an electronic commerce method comprising the steps of:
a) a customer presenting a carrier device to an issuing party;
b) the issuing party storing at least one electronic coupon on the carrier device;
c) the issuing party storing or updating an encoded contract on the carrier device, the encoded contract including a redemption condition relating to the or each coupon, wherein the or each redemption condition includes a specified range of dates during which its respective coupon may be redeemed.

In the present invention, each electronic coupon can only be redeemed during a specified range of dates. The range of dates covers at least one day. Thus the carrier device includes embedded conditions representing a presigned contract for the sale of goods or services. The carrier devices can be offered for sale at a considerable discount, compared to the total retail value of the products or services to which the coupons relate, due to the conditions attached for redemption of the coupons. Each of the coupons can be redeemed during a range of dates, and if the coupon is not redeemed during the specified range of dates it then it expires and can no longer be exchanged.

Another advantage of the present invention is that, because the redemption conditions are stored on the carrier device and are verified by the redemption party on reading the electronic contract, no online authentication of the coupon is required. At the point of sale, the redemption party reads the coupon, verifies that the date is within the range specified in the redemption condition and updates the coupon to indicate that the coupon has been redeemed. No verification with any external network or database is required, although optionally the redemption party may periodically exchange information with an external network, for example daily. This would enable data regarding lost or stolen cards to be exchanged to allow card and/or subscription replacement. In addition, this would allow for market trends to be analysed. This would also enable subscriptions to be updated, such that new coupons can be uploaded onto the card by the redemption system.

The carrier device can also be re-used or updated to add additional coupons. The customer obtains additional coupons from an issuing party to add to a card that the customer has previously obtained.

Preferably, the range of dates is different for each coupon. The specified range of dates may overlap for each coupon, but preferably each range does not overlap with a range for another coupon.

Preferably, the coupons are exchanged for products. An example of a preferred method and system would be a sale of subscription to a publication wherein each coupon on the carrier device represents an issue and can only be redeemed during the range of dates corresponding to one issue of the publication. The subscription can be extended by purchase of additional coupons to add to an existing card.

Optionally, the current status and/or notification of transactions can be made available to the subscriber via current Internet technologies, web, e-mail, SMS etc.

The carrier device may be a sticker, in which a memory device is embedded, or a ring/piece of jewellery worn on the body, or a device incorporating a smart chip, semiconductor device or integrated circuit. However, preferably, the carrier device comprises a smart card. The coupon can be read by an embedded certified reader in a vending machine, POS terminal or a certified reader attached to a PC.

Preferably, the range of dates encompasses at least one week, and preferably the range of dates for each coupon do not overlap.

Preferably, the coupon includes an information field indicating the nature of the product or service for which the coupon is valid. Thus, a single card may be used to store a number of different subscriptions. For example, in the case of subscriptions to publications, an existing card can be used to add a subscription to a different publication.

As well as a specified time period, the redemption condition may also relate to the geographical location of the redemption party, or may be linked to the purchase of other items.

### BRIEF DESCRIPTION OF THE DRAWINGS

Preferred embodiments of the present invention will now be described with reference to the accompanying drawings, in which:

FIG. 1A illustrates schematically a carrier device having a plurality of subscriptions each comprising a plurality of electronic coupons;

FIG. 1B illustrates schematically a single subscription comprising a plurality of electronic coupons;

FIG. 2 is a flow chart illustrating the method of redemption of the coupons;

FIG. 3 illustrates a redemption system;

FIG. 4 illustrates a second embodiment of a redemption system; and

FIG. 5 illustrates a third embodiment of a redemption system.

### DESCRIPTION OF THE PREFERRED EXAMPLES

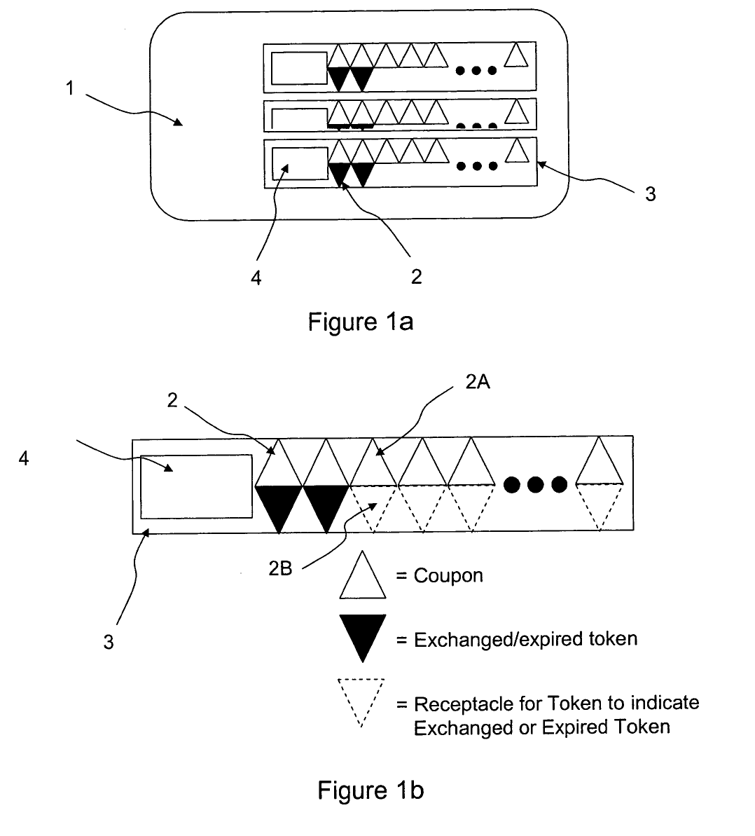

FIG. 1A illustrates a carrier device in the form of a smart card 1, the smart card 1 having a plurality of electronic coupons 2 stored thereon. The electronic coupons 2 are arranged as a plurality of subscriptions 3, each subscription 3 having a series of coupons 2 and an encoded contract 4 associated with the series of coupons 2. Each subscription 3 relates to a different product or service, and one coupon 2 is exchangeable for a specified quantity of product or service. The contract 4 includes a redemption condition for redemption of each coupon 2, the redemption condition including a range of dates during which the coupon 2 can be exchanged. The redemption condition may additionally include further conditions such as conditions relating to the location of exchange for each coupon 2.

FIG. 1B illustrates in more detail a single subscription 3. Each coupon 2 includes a data field 2A representing a quantity or type of product or service for which the coupon may be exchanged, and a second data field 2B to be used to indicate when the coupon 2 has been exchanged or has expired.

An example of an encoded contract 4 for a subscription 3 to a monthly publication is that the subscription 3 includes twelve coupons 2, the first coupon 2 being exchangeable for a single publication during the month of January, the second coupon 2 being exchangeable for a single publication only during the month of February etc. The contract 4 may include additional conditions such that exchange may only be at a specified newsagency or may be at any newsagency in a certain area. If a coupon 2 is not redeemed within the range of dates specified in the contract, then it expires and cannot be redeemed. Data field 2B is used to indicated exchanged or expired coupons.

The present invention may be used in other fields besides publishing. For instance, a coffee shop may sell a card 1 having five coupons 2 stored thereon, wherein each coupon 2 can be exchanged for a single cup of coffee. The contract 4 includes the condition that each coupon 2 may only be exchanged on a single different day of the week (Monday to Friday) at that particular coffee shop.

Other possible examples would be prepaid video hire, wherein a years worth of hire can be sold at bulk rates, with one overnight and seven weekly hires to be taken each week. In this case, data field 2A indicates whether the coupon relates to an overnight hire or a weekly hire.

An example wherein conditions relating to location of exchange may be useful may be in the tourism sector. For instance, a subscription could include three nights stay in January at a luxurious resort provided it is in Victoria and may also include further coupons valid for nights in, for instance, May in New South Wales.

A further possible exchange condition may be that coupon exchange may be linked to another purchase.

A further embodiment of the invention is in a supermarket loyalty scheme. A customer would be given a loyalty card and, on spending certain amounts of money, would obtain coupons which would be added to the card at the point of sale. The encoded contract would be updated to include a redemption condition associated with each added coupon, which would probably be in the form of an expiry date. Each coupon would be valid for exchange or discount for products or services, for instance a discount on fuel purchase at a certain outlet chain.

The smart card 1 may be a Mifare contactless IK memory smart card. This card provides 15 sectors of 3 blocks with 16 bytes of data. In this case, each block would be used to store a subscription 3. One additional sector, sector zero, would be used to store card relevant data, specifically the signature of the card manufacturer, the card issuing authority, the date of birth of the card, the register to record the last transaction details and a reference to the printed record of contract.

Sectors 1 to 7 would be used to store the possible 21 subscription contracts. Sectors 8-14 would be used to store backup copies of the 21 possible subscriptions. Sector 15 would be reserved for a secondary use for the card, like security, etc.

Each of the 21 subscription contracts would by 16 Bytes in length and would start with a common header of 4 bytes.

Header

RegistryCode—A 2 byte digital signature one of a possible 65536 Issuing Authorities

ContractType—A 2 byte digital representation of a possible 65536 possible types

Contract

ContractData—various see below, terms and details of the contract.

ContractIssue—various see below, what has been exchanged to date.

### EXAMPLES OF CONTRACT TYPES

Contract Type 00.

This is a regular interval subscription for a delayed start of up to 90 years, then a regular exchange from 1 up to 128 days apart for up to 80 instances.

Contractdata
DaysToStart—2 bytes. Number of days from birth of card up to 65536 days
DaysInterval—1 byte. Number of days between regular exchanges, 256 days
IssuedData—8 bytes. Each bit for a one-to-one issue record, 64 instances.
Parity—1 Byte parity bit to ensure data integrity.
   Contract Type 01

This is an irregular subscription for up to 8 exchanges. Date of first exchange is up to 90 after birth of card. Remaining dates are calculated by the number of days between each individual instance for an irregular time of 1 day up to 128 days.

ContractData
NumberOfExchanges—1 Byte.
DaysToStart—2 bytes. Number of days from birth of card up to 65536 days
DaysToNextTokenArray—8 Byte. 8×1 Byte days to next token up to 256 days.
Parity—1 Byte parity bit to ensure data integrity.
   Contract Type 02
   This is a subscription with last issue to be by specific number of days after birth of card up to 90 years. Up to 64 exchanges.

ContractData
NunberOfExchanges—1 byte
DaysToContractExpiry—2 bytes
IssueData—8 Bytes, Each bit for a one-to-one issue record, 64 instances.
Parity—1 Byte parity bit to ensure data integrity.
   Contract Type 03

This is a subscription with expiry and issue record of date exchanged no more than 128 days apart for 8 exchanges.

ContractData
NumberOfExchanges—1 Byte, up to 256 instances.
DaysToContractExpiry—2 Bytes
IssueData—8 Bytes. 8×1 Byte array recording age of exchange in days.
Parity—1 Byte parity bit to ensure data integrity.
   Contract Type 04

Similar to Type 03 except only 4 exchanges but greater than 256 days (up to 179 years) apart.

ContractData
NumberOfExchangs—1 Byte, up to 256 instances.
DaysToContractExpiry—2 Bytes
IssueData—8 Bytes. 4×2 Bytes array recording age of exchange in days.
Parity—1 Byte parity bit to ensure data integrity.

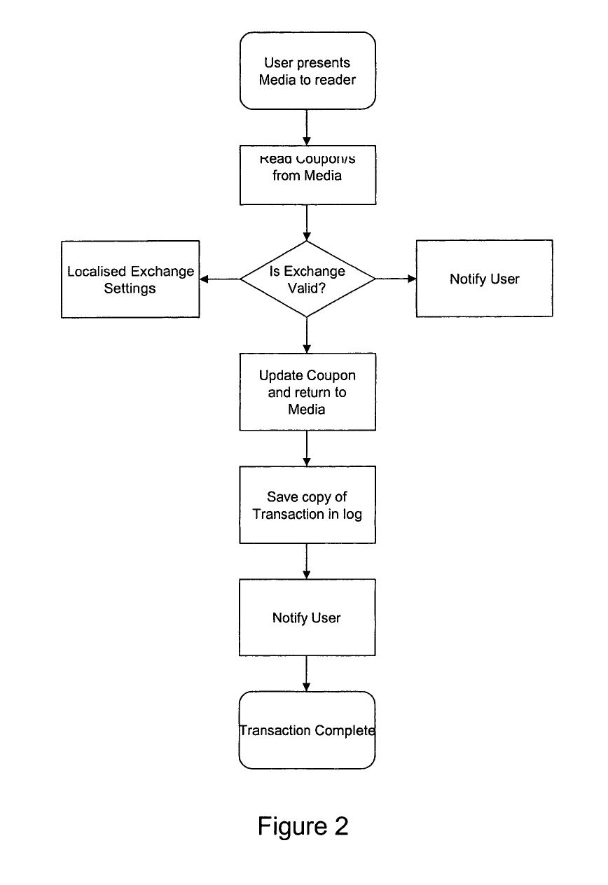

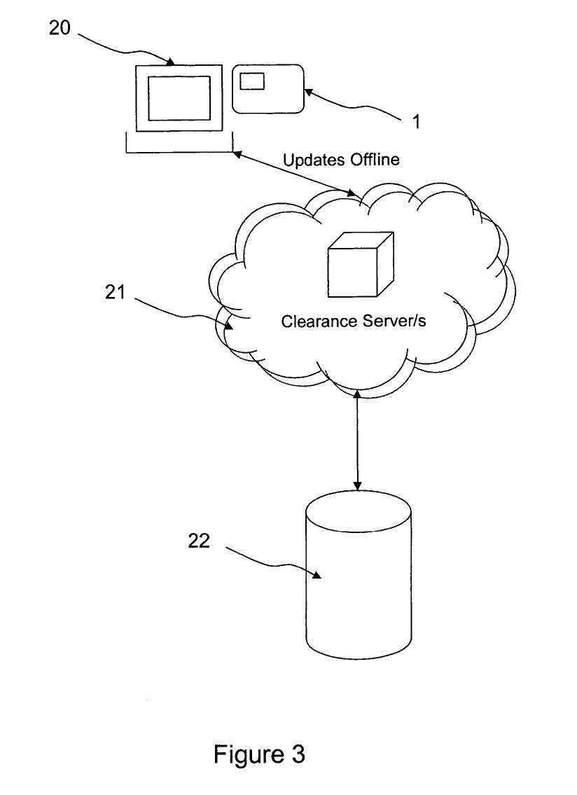

FIG. 2 illustrates the process of redemption of a coupon 2 stored on the smart card 1 and FIGS. 3 to 5 illustrate redemption systems. An issuing party issues to a customer a smart card 1 in exchange for a fee. The customer presents the smart card 1 to a redemption party such as a newsagent, and the redemption party inserts the smart card 1 into a reader 20. The reader 20 reads a coupon 2 on the smart card 1 and the contract 4 and verifies with its localised settings such as date, physical location, trader's details etc whether the redemption condition for redemption of the coupon 2 is satisfied. If the condition is satisfied, the reader 20 notifies the redemption party that the exchange is valid and updates the smart card 1 to indicate that the coupon 2 has been redeemed. The reader 20 saves a copy of the transaction in its log, notifies the redemption party that the coupon 2 has been redeemed and then the redemption party may return the card 1 to the customer.

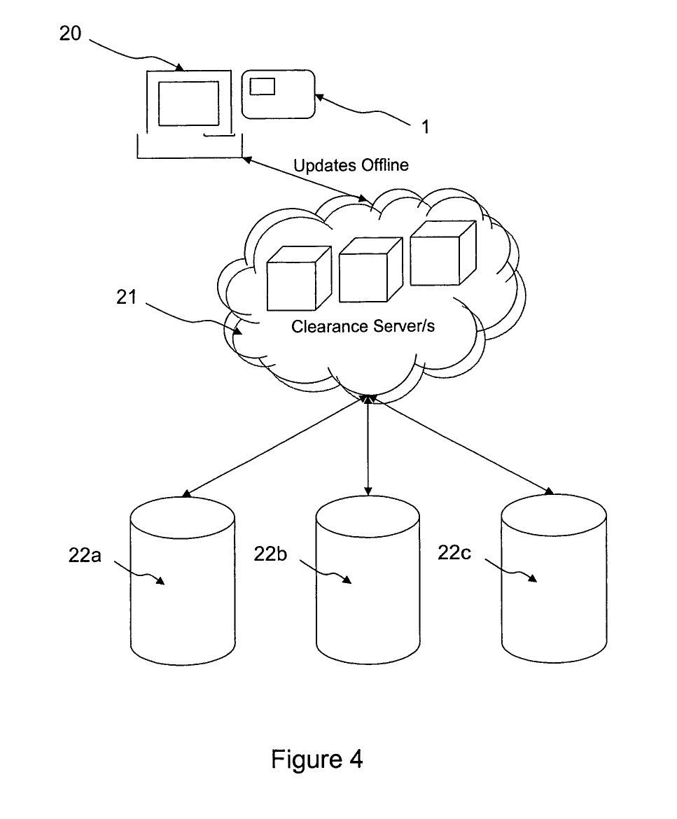

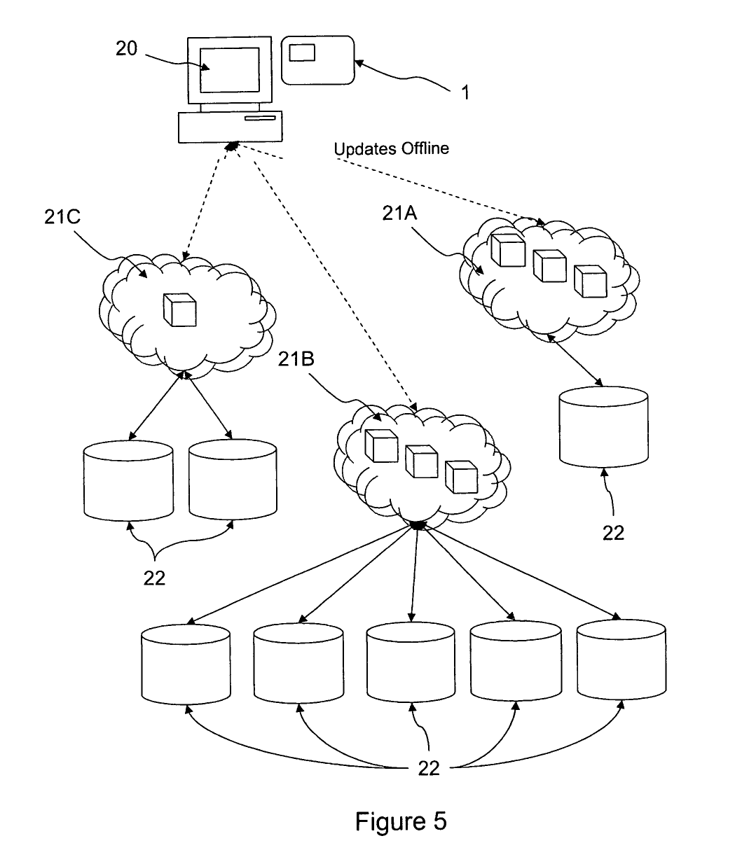

As shown in FIG. 3, the smart card reader 20 stores a record of transactions and periodically updates offline by transmitting its transaction log to a clearance server 21 which transmits the information to an issuing party in the form of a coupon registry 22. The coupon registry 22 can then reimburse the redemption party for the purchase made using the smart card 1. As illustrated in FIG. 4, a single clearance server 21 can transmit information to multiple coupon registries 22A, 22B, 22C. As shown in FIG. 5, there may be multiple clearance registries 21A, 21B, 21C and multiple coupon registries 22.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It is to be understood that a reference herein to a prior art publication does not constitute an admission that the publication forms a part of the common general knowledge in the art in Australia, or any other country.

1. An electronic commerce method comprising the steps of:
a) an issuing party issuing to a customer a carrier device having a plurality of electronic coupons stored thereon, in exchange for a fee, wherein the carrier device includes an encoded contract including a redemption condition relating to each coupon, wherein each redemption condition includes a specified range of dates during which its respective coupon may be redeemed;
b) the customer presenting the carrier device to a redemption party;
c) the redemption party electronically reading the encoded contract and verifying whether the redemption condition is satisfied; and
d) if the redemption condition is satisfied, updating the coupon to indicate that the coupon has been redeemed.

2. A method according to claim 1, wherein the redemption party periodically exchanges information in the form of a transaction log with an external network.

3. A method according to claim 1, wherein the range of dates is different for each coupon.

4. A method according to claim 3, wherein the range of dates for each coupon does not overlap with a range for any other coupon.

5. A method of selling a subscription to a publication according to claim 1, wherein each coupon on the carrier device is valid for exchange for an issue of the publication and can only be redeemed during the range of dates corresponding to one issue of the publication.

6. A method according to claim 1, wherein the carrier device comprises a smart card.

7. A method according to claim 1, wherein the range of dates encompasses at least one week for each coupon.

8. A method according to claim 1, wherein each coupon includes an information field indicating the nature of the product or service for which the coupon is valid.

9. A method according to claim 1, wherein the redemption condition also specifies a geographical location of the redemption party.

10. An electronic commerce system comprising:
a) an issuing party;
b) a carrier device issued to a customer by the issuing party in exchange for a fee, the carrier device having a plurality of electronic coupons stored thereon, wherein the carrier device includes an encoded contract including a redemption condition relating to each coupon, wherein each redemption condition includes a specified range of dates during which its respective coupon may be redeemed;
c) a redemption party having a reader device capable of reading the carrier device presented by the customer, electronically reading the encoded contract and verifying whether the redemption condition is satisfied and, if the redemption condition is satisfied, updating the coupon to indicate that the coupon has been redeemed.

11. A carrier device having a plurality of electronic coupons stored thereon, wherein the carrier device includes an encoded contract including a redemption condition relating to each coupon, wherein each redemption condition includes a specified range of dates during which its respective coupon may be redeemed.

12. An electronic commerce method comprising the steps of:
a) a customer presenting a carrier device to an issuing party;
b) the issuing party storing at least one electronic coupon on the carrier device;
c) the issuing party storing or updating an encoded contract on the carrier device, the encoded contract including a redemption condition relating to the or each coupon, wherein the or each redemption condition includes a specified range of dates during which its respective coupon may be redeemed.

13. An electronic commerce method according to claim 12, further comprising the steps of:
d) the customer presenting the carrier device to a redemption party;
e) the redemption party electronically reading the encoded contract and verifying whether the redemption condition is satisfied; and
f) if the redemption condition is satisfied, updating the coupon to indicate that the coupon has been redeemed.

14. An electronic commerce method according to claim 12, wherein the issuing party stores a plurality of electronic coupons on the carrier device.
